(19) United States
(12) Patent Application Publication
(10) Pub. No.: US 2007/0266344 A1
(43) Pub. Date: Nov. 15, 2007

(54) Browsing Stored Information

(76) Inventors: Andrew Olcott, Newtonville, MA (US); Lisa Debettencourt, Lowell, MA (US); James T. Hotary, Princeton, MA (US); Richard Moon, Sudbury, MA (US); John Michael Sakalowsky, West Newton, MA (US)

Correspondence Address: FISH & RICHARDSON PC, P.O. BOX 1022, MINNEAPOLIS, MN, 55440-1022, US

(21) Appl. No.: 11/681,719

(22) Filed: Mar. 2, 2007

Related U.S. Application Data
(63) Continuation-in-part of application No. 11/317,558, filed on Dec. 22, 2005.

(51) Int. Cl. G06F 3/048

(52) U.S. Cl. 715/841

(57) ABSTRACT

A method for graphically representing content of a database in an automobile entertainment system. The method includes presenting a primary display element on a display, wherein the primary display element represents a first node in a first hierarchical level of the data base; and presenting a secondary display element on the display, wherein the secondary display element includes a graphical indicator that varies in size according to the number of nodes in a second hierarchical level below the first hierarchical level of the database. A method for graphically representing data base elements on a display, includes causing an icon to appear on a display, the icon representing a first node in a first hierarchical level of a data base; causing a ring to appear around the icon; and highlighting an arc of the ring, the arch described by an included angle, wherein the magnitude of the included angle is related to the number of elements in a hierarchical level below the first hierarchical level associated with the first node.

### CLAIM OF PRIORITY

This application is a continuation-in-part of and claims priority of U.S. patent application 11/317,558 of Andrew Olcott, Lisa deBettencourt, James T. Hotary, Richard Moon, and John Michael Sakalowsky, file on Dec. 22, 2005, the entire contents of which are incorporated by reference in its entirety.

### BACKGROUND

This description relates to browsing stored information.

In typical display-based navigation systems used in vehicles, for example, user interface controls such as buttons on a dashboard console enable a user to browse through lists of words or phrases representing items in a database of stored information such as information about interstate highways, state roads, and streets. It has also been proposed to enable a user to scroll back and forth through displays of individual segments of a route based on information stored in a database.

### SUMMARY

In general, in one aspect, a geographical field is displayed indicia, representing respective items stored in a navigation system that are displayed in positions that correspond to geographic relationships of the items on the geographic field. In response to a user manipulating a user interface control device, a visible feature of the geographic field is altered to indicate browsing with respect to a predetermined succession of the stored items.

Implementations include one or more of the following features. The altering of a visible feature comprises changing an appearance of at least one of the indicia. The items comprise points of interest in a vicinity of a route on the geographical field. Text identifiers of at least some of the selected items are also displayed in positions that do not correspond to geographic relationships of the items. The indicia are displayed as a hub representing one of the items and spokes representing other items that have a geographical relationship to the one item, the angles of the spokes and the distances separating the hub and the spokes being representative of the directions and distances among the items represented by the hub and the spokes. The user is enabled selectively to cause, at one time, either a geographical display of the indicia, text identifying the selected items, or both a geographical display of the indicia and text identifying the selected items. The geographical field is represented as a map of a region being navigated and the indicia are displayed on the map. The stored items are organized in hierarchical levels. The items represented by the indicia belong to one of the levels. The user if enabled to select items at each of at least two different hierarchical levels by manipulating the user interface. The items comprise points of interest. A cursor is displayed to indicate currently selected items. In response to a user request, additional information is provided about currently selected items. The manipulating of a control device comprises turning a knob. The visible feature of the geographic field comprises a cursor, and altering the visible feature comprises causing the cursor to point to successive indicia representing the stored items. The predetermined succession of items is determined automatically. The user manipulating the user interface control device is not associated with an inherent geographic aspect. The user manipulating the user interface control device requires no knowledge by the user of the location on the geographical field of the next item in the predetermined succession of items.

In another aspect, a ;method for graphically representing content of a database in an automobile entertainment system includes presenting a primary display element on a display, wherein the primary display element represents a first node in a first hierarchical level of the data base; and presenting a secondary display element on the display, wherein the secondary display element includes a graphical indicator that varies in size according to the number of nodes in a second hierarchical level below the first hierarchical level of the database. The primary display element may include an icon representative of the first node. The secondary display element may include a ring-shaped graphical element. The graphical indicator may include a highlighted arc within the ring-shaped graphical element. The highlighted the arc may be described by a central angle equal to

$$\frac{m}{n} \times 360$$

degrees, where n is the number of nodes in the second hierarchical level below the first hierarchical level that are associated with the first node, and m is one of 1 and the number of nodes in the hierarchical level below the first hierarchical level that are represented on the display. The number n may be equal to 1 and the and method may further include highlighting an arc of the ring, the arc described by a central angle equal to

$$\frac{1}{{n}_{max}} \times 360$$

degrees when n is equal to or greater than nₘₐₓ. The m may be the number of nodes in the hierarchical level below the first hierarchical level that are represented on the display and the method may further include highlighting an arc of the ring, the arc described by a central angle equal to

$$\frac{m}{{n}_{max}} \times 360$$

degrees when n is equal to or greater than nₘₐₓ. The method may further include causing the arc to be displaced from a starting point by an angular and representing an incrementing through the n nodes by incrementing the angular distance by

$$\frac{1}{n} \times 360$$

degrees.

In another aspect, in an automobile entertainment system, a method for graphically representing elements of database comprising a plurality of nodes that are arranged in a predetermined order includes providing a control knob for navigating through nodes presented on a display of the vehicle entertainment system; presenting on the display a first graphical element representative of a selected node; and presenting on the display a second and third graphical element associated with a respective second and third node that are each adjacent to the selected node in the predetermined order, wherein the first, second and third graphical elements are arranged in an approximately circular or semi-circular fashion such that as the control knob is rotated selection between the first, second, and third graphical elements is similarly rotated. The first graphical element may include a graphical indicator that graphical shows the number of sub-selections under the selected node. The graphical indicator may include a highlighted are within a ring. The method may further include causing a fourth graphical element associated with a fourth node to appear on the screen as the user rotates the control knob. The first, second and third graphical elements may move on the display in the rotary direction of the control knob when rotated by the user. The entertainment system may further include a second control knob for selecting between sub-selections under the selected node. The second control knob may be concentric with the first control knob. The graphical indicators may move as the second control knob is rotated.

In another aspect, a method for displaying audio signal sources each audio signal source corresponding to one of a plurality of preset indicators includes on a display screen, adjacent a first preset indicator, displaying an audio signal source corresponding to the first preset indicator; displaying adjacent a second preset indicator a first graphical indicator that there are additional audio signal sources each corresponding to one of the plurality of reset indicators; and upon selection of the second preset indicator, displaying a second audio signal source corresponding to the first preset indicator. The number of audio signal sources may be greater than the number of preset indicators. The number of audio signal sources may be greater than the number of preset indicators. The method may further include displaying adjacent a third preset indicator a second graphical indicator that there are additional audio signal sources each corresponding to one of the plurality of present indicators; and upon selection of the third preset indicator displaying a third audio signal source corresponding to the first preset indicator.

In another aspect, an audio system includes a number N of input elements each associated with a particular radio station such then when the input element is actuated by a user the audio system tunes to the particular radio station; and a user interface that permits the user to change the number of particular radio stations that may be stored from a first value to a second value, wherein at least the second value is greater than N.

In another aspect, a method for graphically representing data base elements on a display includes an icon to appear on a display, the icon representing a first node in a first hierarchical level of a data base; causing a ring to appear around the icon; and highlighting an arc of the ring, the arc described by an included angle, wherein the magnitude of the included angle is related to the number of elements in a hierarchical level below the first hierarchical level associated with the first node. The position of the arch along the circumference of the ring may be related to the position of a highlighted element of the hierarchical level below the first hierarchical level within its hierarchical level. The magnitude of the included angle may be inversely proportional to the number of elements in the hierarchical level below the first hierarchical level associated with the first node. The display may be associated with a vehicle entertainment system. The display may be further associated with a vehicle navigation system.

Other general aspects include other combinations of the features recited above and other features expressed as methods, apparatus, systems, program products, and in other ways.

Other advantages and features will become apparent from the following description and from the claims.

### DESCRIPTION OF DRAWINGS

FIGS. 1A and 13A are block diagrams.

FIGS. 1B, 6A, 8A, 9A, and 13B show hierarchies.

FIGS. 1C, 2A, 2B, 2C, 3A, 3B, 4A, 4B, 5, 6B, 7A, 7B, 8B, 8C, 8D, 8E, 9B, 11A, 11B, and 12 show screen shots, in some cases with hierarchies.

FIG. 10 shows an icon.

FIG. 14 is a simulated screen shot.

FIGS. 15A and 15B show a ring icon.

FIGS. 16A-16D show preset indicators and an adjacent portion of a display.

### DETAILED DESCRIPTION

By improving the way a user can visually browse records stored in a database, finding items of interest and understanding their significance (for example, the location of Chinese restaurants on a displayed regional map) becomes faster, easier, and more intuitive. The records in the database may relate to (and provide information about) items that are not simply route segments, but rather are attractions in the vicinity of, or supplemental features of, a route or a region or other spatial field that is being displayed textual hierarchy of the items to select one or more nodes or leaves of the hierarchy of items (for example, restaurants that serve Italian food). Once the nodes or leaves are selected, the user can visually browse the items in those nodes or leaves, on item at a time, back and forth, using a user interface device such as a knob to select a current item of interest. The user can alternate between browsing the hierarchy and browsing the items in selected nodes or leaves of the hierarchy because the display can show both the textual hierarchy and a map of the items of that are selected in the hierarchy at a given time. Or the textual hierarchy, can be hidden to permit a more complete map display of the items being browsed.

The items of the selected portion of the hierarchy are indicated by icons or other indicia displayed on a map (or other two-dimensional or three-dimensional representation). All of the items in that portion of the hierarchy can be indicated simultaneously on the map. The current item of interest selected by the user can be distinguished visually using different indicia than are used for the other displayed items that are not the currently selected item. Displaying all of the items of the portion of the hierarchy at once while highlighting a selected one of them enables the user to comprehend easily the relationship of the different items to the local region and their relationship to one another and their relationship to a current vehicle location.

In other examples, the intersections of roads may be organized hierarchically in the database, and the users can select a set of intersections from the hierarchy and then browse successive intersections within that set (for example, all roads that intersect Main Street in Bristol, R.I.). The roads selected need not have nay relationship to a current position of the vehicle or to a programmed route.

In the examples described above, the hierarchy of items in the database is not displayed explicitly on the map. Rather only the items within a selected portion of the hierarchy are displayed on the map as the user browses. In some examples, however, the hierarchy is explicitly displayed. In some cases, the hierarchical display provides an abstracted rather tan literal view of the positional relationships among the levels of the hierarchy and the items of a given node or leaf. The display, for example, can use a hub and spoke approach to display the geographical relationships of countries, states, and towns.

In some examples, it would also be possible to display the hierarchical relationships of items in the database on the map itself. Items that are displayed on the map generally have a geographic aspect. Items at any level of the database hierarchy that exhibit such a geographic aspect, can be displayed, for example, all Italian restaurants or all Chinese restaurants. For example, all attractions could be indicated by a relatively small unobtrusive visual indicia on the map. All gasoline stations could then be indicated by another, slightly more noticeable indicia, all restaurants by a different indicia, and so on. All Chinese restaurants could be shown by an even more noticeable indicia, and so forth. Each restaurant could be shown by a knife and fork icon, for example, and each Chinese restaurant by the same knife and fork icon with a Chinese character overlaid on it. In some cases, the user could be permitted to choose multiple nodes and leaves of the hierarchy for visual display and exclude others. For example, the user could select Chinese restaurants and Italian restaurants to see whether the nearest Italian restaurant (his second favorite cuisine) is much closer than any Chinese restaurant (his favorite cuisine).

Each time a user moves from one item to a new current item from the database, details about that item stored in the database may be displayed (for example the address or telephone number of the restaurant).

The user is also enabled to zoom in and out with respect to the displayed map to see more or less detail, and the zooming can be done in conjunction with each of the successive currently selected items. For example, when the user has currently selected the China Moon restaurant, he can zoom in on the portion of the map in the vicinity of the icon that indicates the location of that restaurant. He can then change the current item to another Chinese restaurant and zoom on that one. Separate controls can be provided for that purpose.

Sometimes we use the phase geographical field broadly to refer, for example, to all of the displayed elements that have geographic meaning or are related to elements that have geographic meaning, including the map, cursors, text, roads, points of interest, and other indicia displayed with map or any of the other geographical elements.

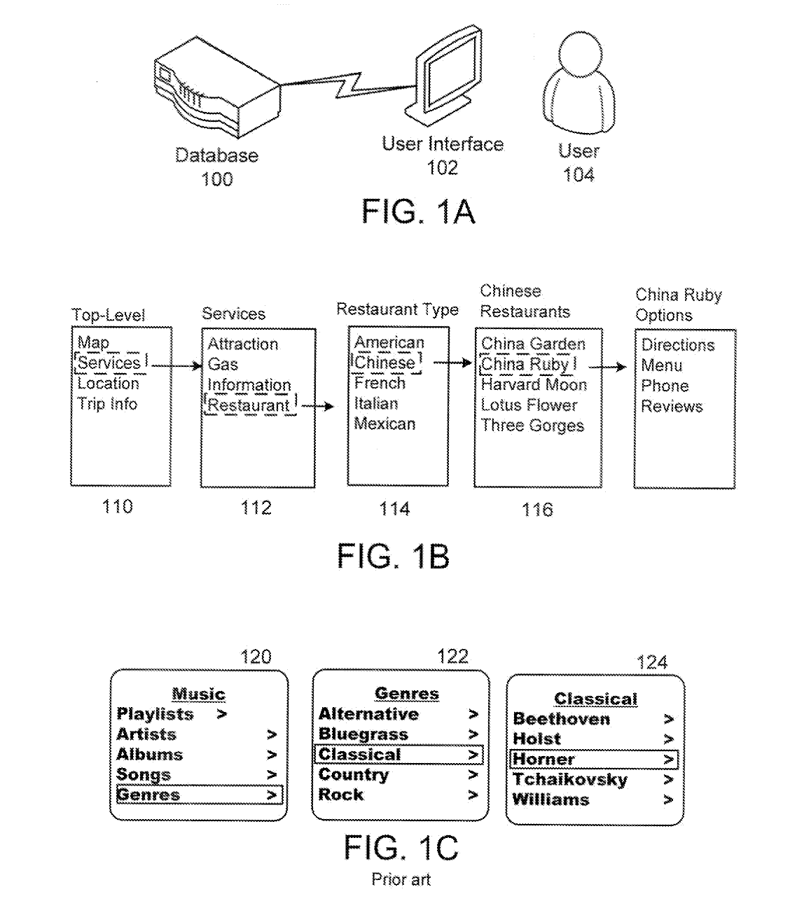

As illustrated in FIG. 1A, a database 100 of records can be accessed and browsed by a user 104 using controls of a user interface 102. The user interface 102 and the database can be part of any of a wide variety of devices including a genera-purpose computer running an operating system and applications to manage the database and the interface, among other things. Other devices could include dedicated workstations, portable computers, and hand-held devices including personal digital assistants and mobile telephones. In addition, the user interface and the database could be operated on two or more different devices, and the devices could be in the same location or different locations. Different devices could interact through any kind communication network including a local area network, a wide area network, and the internet. The database may include any kind of information.

In some implementations, described by example below, the database includes navigation information useful for a display-based navigation system of a vehicle. The user interface is exposed to the occupants of the vehicle through a console, for example, a dashboard mounted console. The user interface and the database are managed by software running on an on-board computer in the vehicle.

One simple example of a portion of the database 100 is illustrated in FIG. 1B. The records of the database may be organized hierarchically in successive levels beginning with a root node. The root node could represent an action associated with the levels below, for example, “find nearby” Each of the other levels can have multiple nodes. Leaves of the hierarchy occur at the opposite end from the root node. The records in a top level 110 of the hierarchy (in FIG. 1B, the root node is just to the left of the top level node 110) represent functions performed by a vehicle navigation system, e.g. Map (which refers to the display of maps on the navigation system screen), Services (which refers to display of services that may be available to motorists at facilities located on or near the vehicle's route). Location (display of information about the vehicle's current location), and Trip Info (display of information about a current trip of the vehicle).

Each record in the first level 110 of the hierarchy represents a node that is associated with a set of nodes at a second level 112 of the hierarchy. For example, associated with Services in the first level are the nodes Attraction (sites that may be of interest to the vehicle occupants), Gas (places to buy fuel), Information (information about places, geography, history, and the like), and Restaurant (names and other each node in the second level. Continuing the example of FIG. 1B, the restaurant node corresponds to the nodes 114 including American, Chinese, French, Italian, and Mexican. In the fourth level 116, Chinese restaurants are associated with records or China Garden, China Ruby, Harvard Moon, Lotus Flower, and Three Gorges. At the fifth level 118 of the hierarchy of the database in FIG. 1B are the types of information available about each restaurant at the fourth level 116. A sixth level of data, not shown, would contain the actual data from the record referred to in the fifth level 118, for example, the menu of the China Ruby Chinese Restaurant that is a Service of interest to the vehicle occupants. Alternatively, a record in the fifth level 118, e.g. Directions, might link to data external to the database 100. The nodes at the fifth level may be thought of as leaves of the hierarchy.

For a geographical region, the database could include a large number of records and reasonable complex hierarchy of nodes and leaves. This raises the important question: How can the user browse through such a database of information quickly and easily to reach and understand information that is useful to him?

Often browsing is aided by a combination of displaying to the user portions of the hierarchy in text and the information from the records represented by the hierarchy, and enabling the user to indicate choices through devices of a user interface.

In some existing browsing system, information in a database is presented to a user in successive menus corresponding to the levels of a hierarchy, for example, the contents of successive levels of the hierarchy, e.g. categories of music, genres, computers. The user's selection of one record in each screen determines which records from the next level are presented in the next screen.

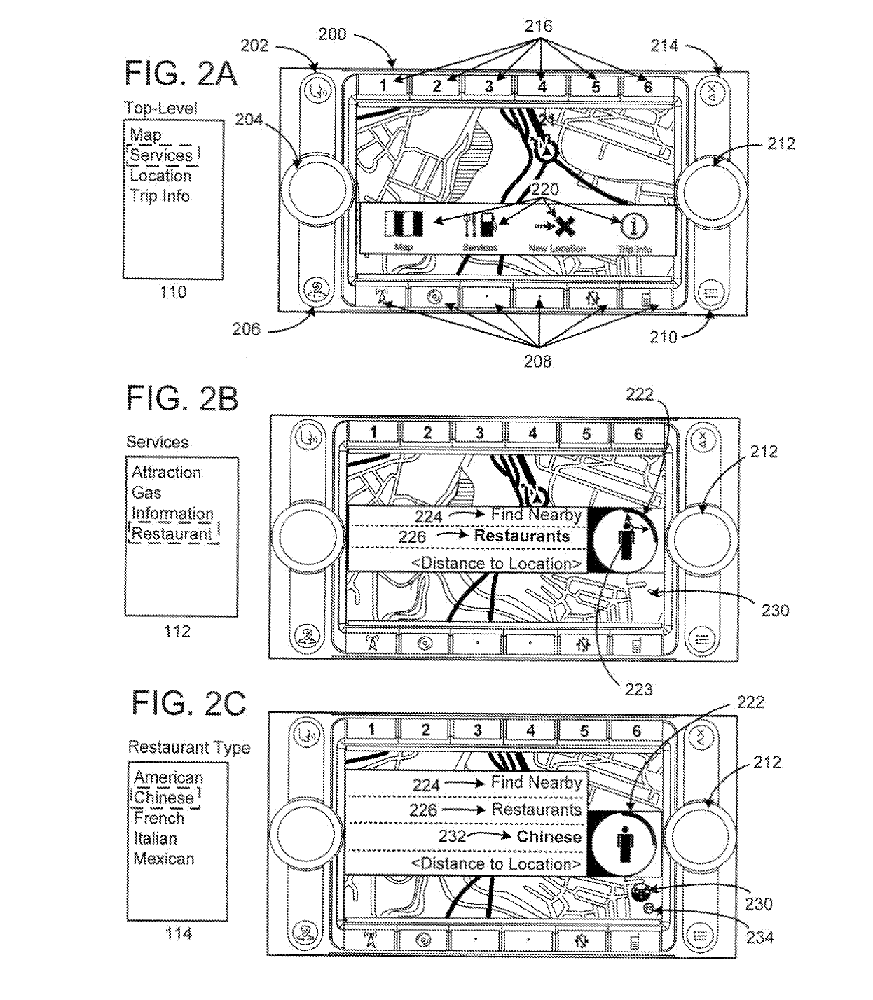

FIGS. 2 through 10 illustrate examples of an improved way to enable a user to browse a database in the context of a vehicle's navigation system.

Referring to FIG. 2A, the interface 200 of the navigation system comprises buttons, knobs, and a display screen combined in a unit that can be mounted in a dashboard of a vehicle, for example. Some buttons, e.g. 202, 206, 210, 214, have specific functions indicated by labels on those buttons. Other buttons, e.g. 208, 216, may have functions that vary depending on the state of the navigation system. Knobs 204, 212 may also have fixed functions or differing functions and may also function as push buttons. The display screen 218 may be a video monitor capable of displaying any image or video stream sent to it, or it may comprise discrete elements such as character displays, individual lights, or static images.

In some examples, as shown in FIG. 2A, the records in a level 110 (from FIG. 1B) of the hierarchical database are represented by icons 220 displayed on a screen 218. The screen may be split for purposes of display so that the icons are shown on the bottom portion and a map is shown on the upper portion. The display of the top level icons as illustrated may be the initial or default display for the system. As shown, in general, the user may select an icon representing a desired function by rotating a designated knob 212 to change which icon is highlighted (in FIG. 2A, it is Service that is highlighted), and then pressing a designated button, which may be the knob 212 used to select the icon.

In some implementations, the user might select a function by directly pressing an icon 220, if screen 218 is sensitive to touch.

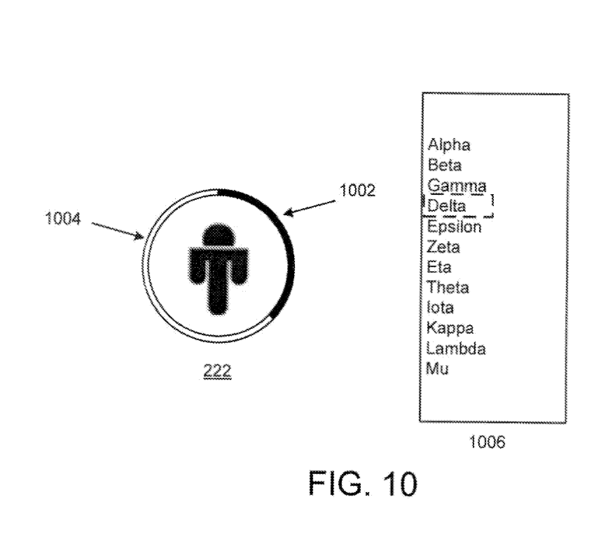

The selecting of one of the icons in FIG. 2A, by a knob and pressing it, causes the display to change to the configuration shown in FIG. 2B, in which selected nodes of the hierarchy at successive levels are displayed, one node per level. In FIG. 2B, only one level of the hierarchy (Restaurants) is shown (in addition to the root node, Find Nearby), and one of the nodes at that level 112 of the hierarchical database is displayed on a line of text 226. The name of the item that was selected in the next higher level is displayed on a higher line of text 224. For the function of locating services, there are multiple ways to define the starting point and scope of the search, for example, services near the vehicle's location, along a calculated route, within a specific city or other area, on a particular cross street, or at a destination or other identified point. In this example, the “Find Nearby”item may represent any of these methods, and does not Ion correspond to the details of the hierarchy shown on earlier figures. The user is able to browse the names of nodes in the level 112 by rotating the knob 212 (FIG. 2A), which changes the name displayed in the line 226 to the successive names (one by one) in a list of the nodes in the level 112 of the hierarchy. A circular icon 222 indicates how far through the list of items in that level of the hierarchy the user has browsed by the angular extent 1002 of the outer ring that is filled in (see FIG. 10, described below). The line of the display that contains the phrase <Distance to Location> indicates an action that can be taken by the user with respect to the selections that appear in the list shown above it. Any of the levels 112, 114 could be visually browsed. For example, one might wish to switch between browsing all Chinese restaurants and browsing all restaurants.

For the third level 114 of the hierarchical database, shown in FIG. 2C, the names of the items at that level are displayed, one at a time, in a third line of text 232, with the selected item in each of the previous two levels displayed in preceding lines of text 224 and 226. The user is able to browse the successive items in level 114 by rotating the knob 212 in the same manner as for FIG. 2B. As with the second level, the icon 222 indicates how far through the list of records in level 114 the user has browsed. At any time and from time to time, whenever the user is browsing in a level of the hierarchy by turning the knob, he can stop browsing, restart again, and reverse direction once or repeatedly. The icon 222 will continue to show at all times the location of the user within the list of items at that leave. Being circular, the icon implies to the user that the list of items is a ring in which the final item is followed by the first item again, and the user can use the knob to browse from the end of the list directly to the beginning of the list.

Also shown in FIGS. 2B and 2C are icons 230 and 234.

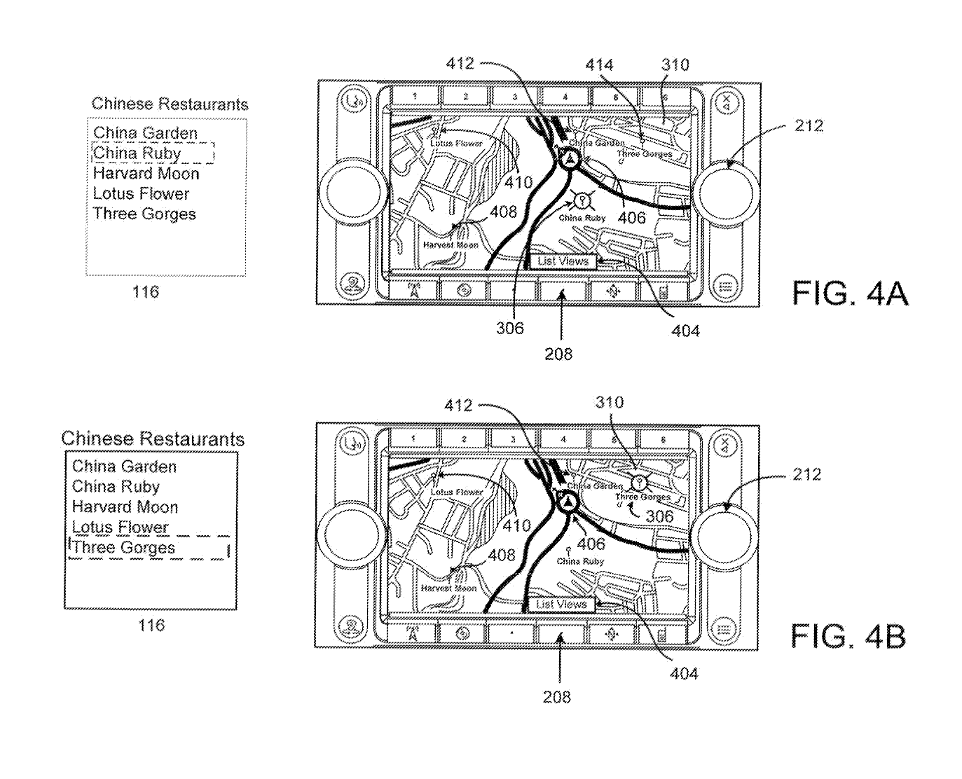

When the information associated with a particular node has a geographic attribute, as in (but not limited to) a navigation system, the information may be displayed visually and the user may be enabled to browse the visual display. For example, for the third level 116 of the hierarchical database, shown in FIG. 4A, the locations of the individual restaurants in that node can be illustrated by icons or other indicia on a map. A cursor 306 indicates the location on a map 310 of the current item selected by the user, a restaurant named “China Ruby”. The textual display of the hierarchy has been hidden in FIG. 4A to permit the user to have an unobstructed view of the map. Several names and pin icons 408, 410, 412, and 414 simultaneously indicate locations of other restaurants on the map 310. An icon 406 indicates the current location of the automobile near the center of the screen, giving additional context to the locations shown for the restaurants. As in the earlier example, rotating the knob 212 browses among the items of the present subset 116. As shown in FIG. 4B, in response to the user turning the knob 212, the cursor 306 has moved to the location on the map 310 of the “Three Gorges” restaurant. Text 404 indicates that pressing the corresponding button 208 will return the user to the traditional list view of the database.

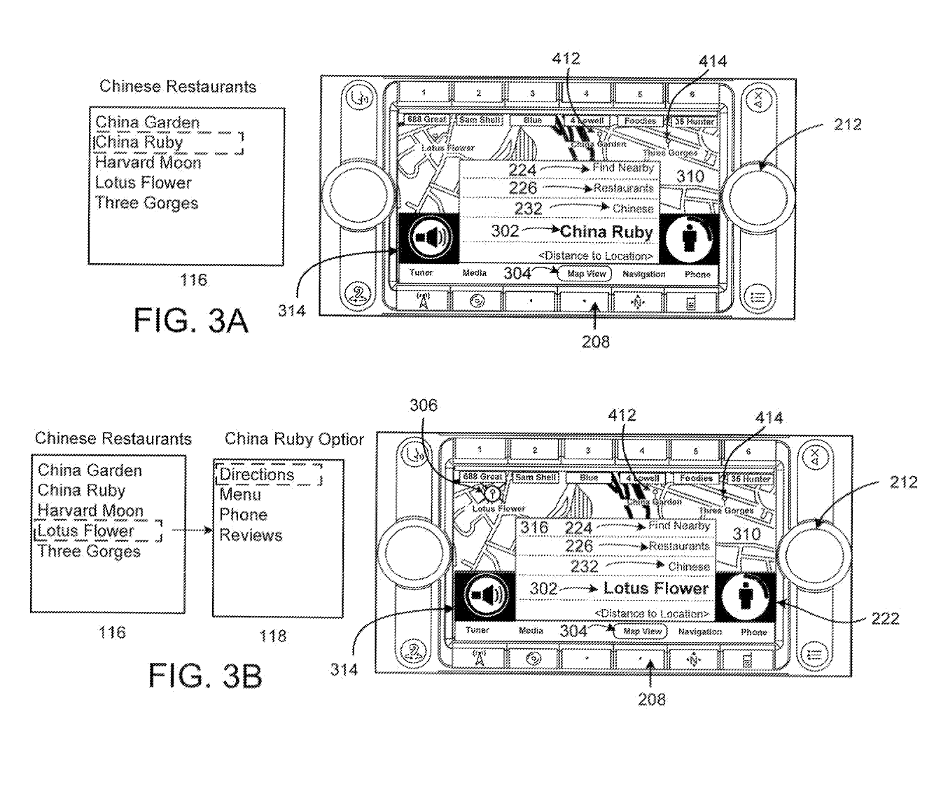

FIGS. 3B illustrates an alternative mode of browsing activated when the user presses the button 208 designated “List View” indicated by the text 404 in FIG. 4A and 4B. The map 310 is still visible and the display of the hierarchy is also displayed. To accommodate the map, the display of the hierarchy has been reduced in size, the icon 222 has been reduced in size and relocated, and a new icon 314 has been added. The names of the restaurants are displayed in a fourth line of text 302, one at a time, with the selected item from each of the previous three levels displayed in preceding lines of text 224, 226, and 232. As with the other levels, the user is able to browse the records level 116 by rotating knob 212 and, icon 222 indicates how far through the list of records in level 116 by the user has browsed.

The restaurant listed on line 302 (FIG. 3B) is identified on the map by an icon (a pin within the cursor 306) the other restaurants in the list (the ones that are present on the portion of the map displayed) are identified by names and pin icons 412 are 414 as in FIG. 4A. The text 404 (FIG. 4A) has been replaced by the text 304, indicating that pressing the corresponding button 208 will return the viewer to the Map View. Using the button 208, the user may toggle back and forth between the view shown in FIG. 3B, which includes the list view showing the list and a portion of the map, and the view, shown in FIG. 4A, for example, in which the list is hidden and only the map is shown. An item highlighted in one view will also be highlighted in other view.

When a user is browsing in one view the information necessary for displaying the other view can be processed in the background. For example, when an item is selected in the list view, the information for rendering the map in the map view can be calculated at the same time, so that the system can switch rapidly to the alternative view when requested to do so by the user. In FIGS. 3A and 3B, one view is overlaid on top of the other view, and both views are updated at the same time. The system may also accommodate highlighting more than one item at a time. For example, all Chinese restaurants may be highlighted, or all Italian restaurants, or all gas stations.

FIGS. 3A and 3B illustrate the change in the display as the user rotates knob 212 to choose among items in level 116. As the knob 212 is rotated, the item listed in 302 changes from “China Ruby” to “Lotus Flower.” Meanwhile, the outer ring of the icon 222 indicates that the user is farther through the records in the preset level, and the icon 306 now indicates the location of the “Lotus Flower” restaurant on the map 310 in the background. Thus the user can browse the database by rotating the knob which causes successive items to be indicated by both the line 302 and the icon cursor on the map.

In the example of FIG. 3A and 3B, an icon 314 representing the volume of the vehicle's audio system is displayed on the left side of screen 218. The current volume level relative to the maximum potential volume level is represented by the extent to which the outer ring of volume icon 314 is filled in.

A line 312 corresponds to the next level 113 of the hierarchy that will be displayed once the user has selected a restaurant in line 302 from level 116. The choice currently shown enables the user to display the distance to the restaurant. Other actions may include <indicate route>.

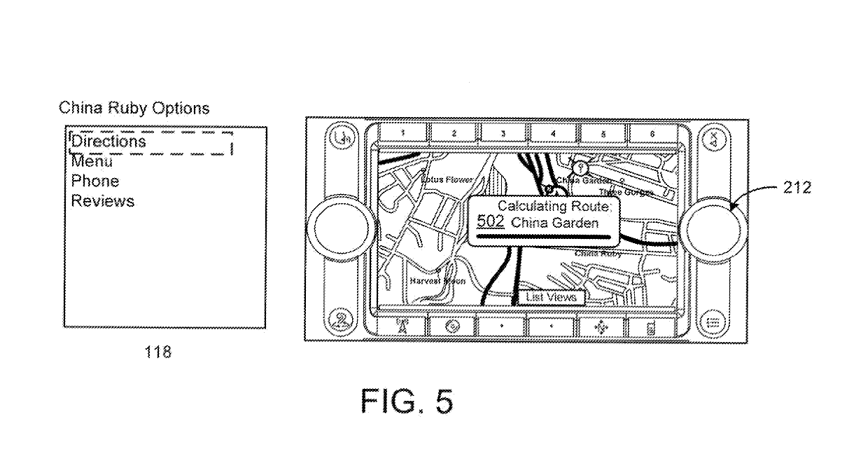

As illustrated in FIG. 5, once a user chooses to see a route to his selected restaurant, as this operation may take some time to complete, the screen 218 may display an indication 502 that the user's request is being processed.

Using the interface illustrated and described above, a user can browse rapidly, easily, and intuitively through a database to find information of interest.

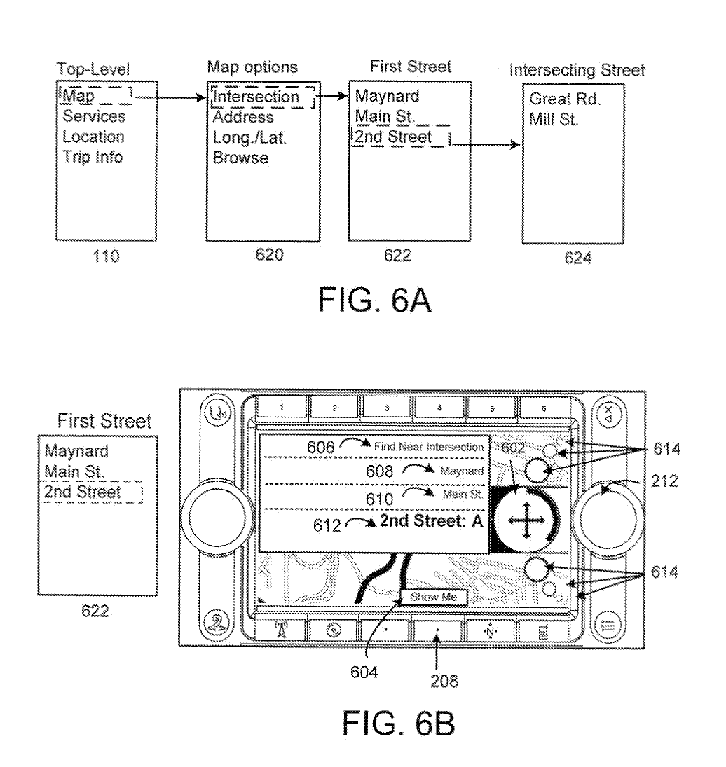

In some implementations, a vehicle navigation system may be used to find a street intersection. FIG. 6A shows an example of the nodes in a hierarchical database that support this function. Other database formats may be used. In a second level 620, records representing various ways of locating a point on a map correspond to the Map service at the top level 110 (from FIG. 1B). For the intersection item, subsets of records in a third level 622 each contain streets that could be the first street of an intersection. A set of records at a fourth level 624 contains streets that intersect 1st Street, the street selected in level 622.

FIG. 6B shows an example of a user interface for accessing intersection information from a database. Line 606 indicates the currently selected mode (in this case, “Find Nearby Intersection”). The line 608 indicates possible cities in which intersections of streets occur. The line 610 indicates possible first streets that could be associated with intersections in the selected city. The line 612 indicates streets that intersect the street selected in line 610. The line 612 is aligned with an icon 602, that indicated (by the drawing of an intersection) the currently active mode that corresponds to the text on line 606. Other possible modes are indicated by icons 614.

Rotating knob 212 would change the selection on line 612 to other streets. The portion of the outer ring of the icon 602 that is darkened indicates how far through the records of the level 622 the user has browsed.

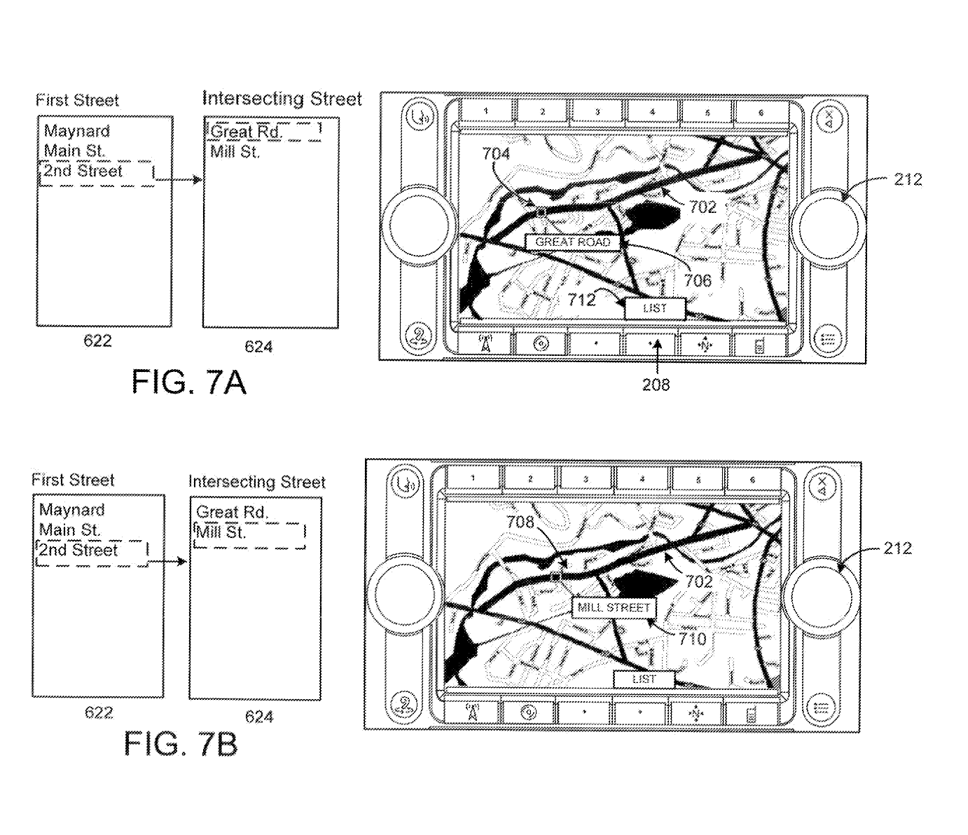

In other examples of selecting a street, in particular a street from level 624 of a database intersecting a previously selected street from level 622, (shown in FIGS. 7A and 7B) a street 702 is darkened to indicate that it has already been selected as the first street of an intersection. An intersection 704 of a second street is indicated by a callout 706, which displays the name of that second street, “Great Road.” The text 712 indicates that the corresponding one of the buttons 208 will toggle the display to a list view of intersecting streets. Turning the knob 212 changes the currently selected intersecting street, as seen in FIG. 7B where intersection 704 (FIG. 7A) has been replaced by the intersection 708, and the callout 706 has been replaced by the callout 710 indicating the name of the newly selected intersecting street, “Mill St.”

A visual display could also be used to select the first street of an intersection, with each possible street highlighted in turn in the same manner that the street 702 is highlighted in FIGS. 7A and 7B. Turning knob 212 may change which street is selected according to a hierarchy, e.g., larger roads are selected first, or longer roads are selected first, smaller roads selected second, or alphabetically, or in order across the screen, or in some other manner.

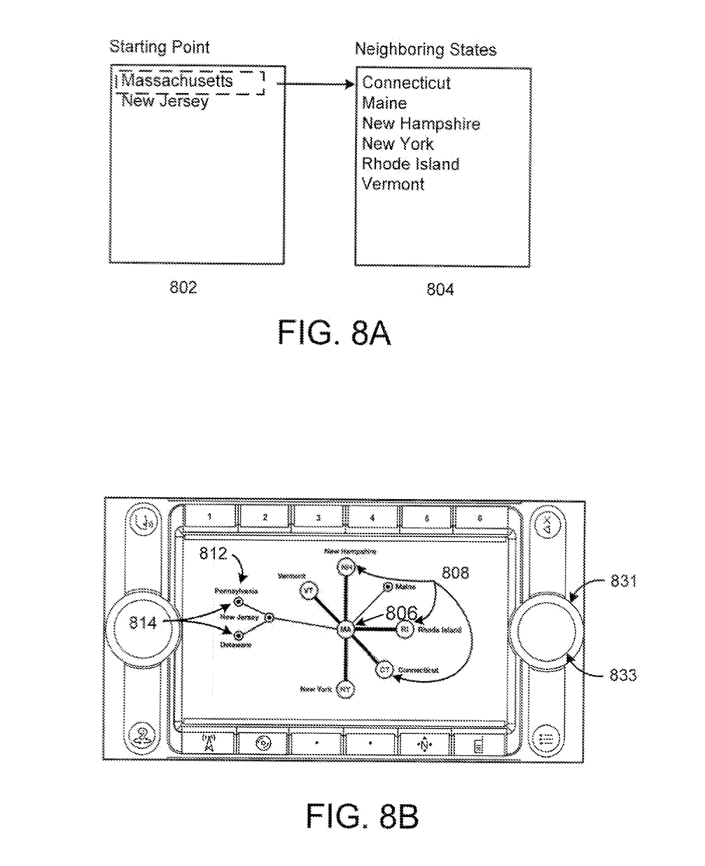

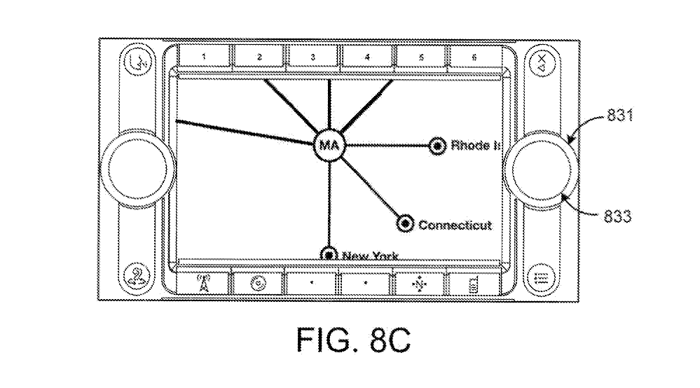

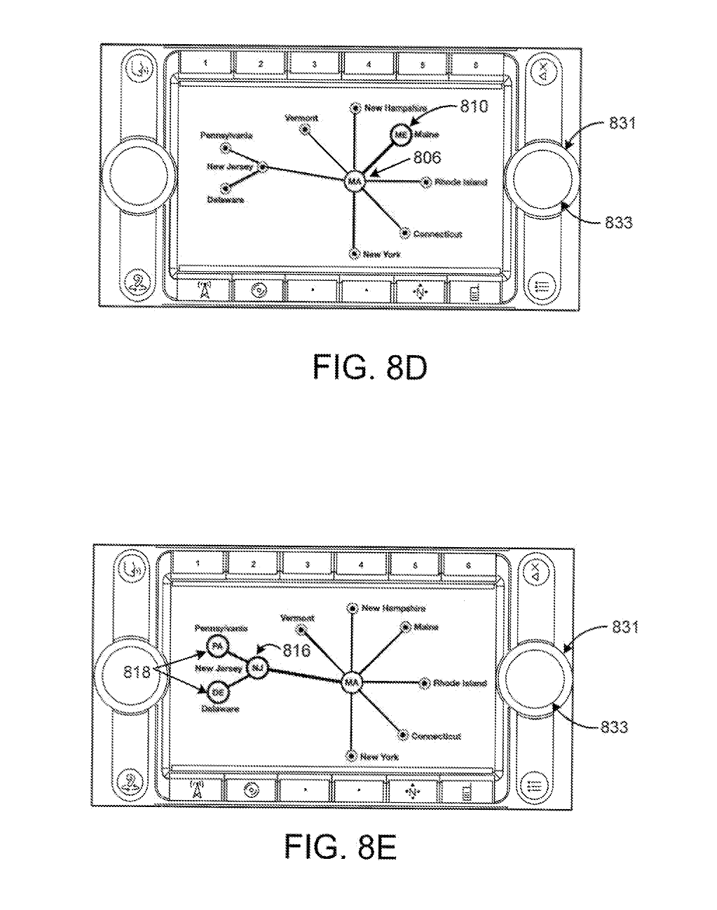

In some implementations, a vehicle navigation system enables a user to browse geographical locations (e.g., possible destinations) using an abstract spatial representation that includes, for example, cities and states. FIG. 8A shows nodes in levels of an example hierarchical database that supports this function. One level 802 of the hierarchy lists states for which the navigation system has location information. Another level 804 contains states neighboring a state selected from the level 802. Other levels may include counties, cities, roads, and intersections, and reflect their adjacency relationships, for example.

FIG. 8B shows an example of a user interface for accessing information from the hierarchical database. The states in levels 802 and 804 are displayed schematically in a hub and spoke display. By providing the user with an interface that is simpler than a typical map, he is able to browse the available destinations more easily; than using a map and without needing to resort to spelling the street name.

The user interface provides an outer knob 831 that enables a user to scroll through the spokes visually to select one. An inner know 833 allows the user to zoom in and out on the selected spoke. FIG. 8C shows the display of FIG. 8B after zooming in.

In the example, a circle hub 806 may be the state in which the user's vehicle is currently located (Massachusetts) or a state that the user has chosen by browsing a list of states or a schematic representation of the states. Neighboring states to the hub state from level 804 of the database are displayed as dots, e.g., the dot 808 for New Hampshire, Rhode Island, and Connecticut. The dots for each neighboring state may be positioned in a direction and at a distance from the circle 806 corresponding to the relative geographic locations of the states. The dots 812 and 814 show additional states that are available in level 802 and 804, respectively, but are grayed because they do not border Massachusetts.

As a user rotates the knob 831, the selected sate changes among the states in the items of level 804, as shown in FIG. 8D, in which Maine is the presently selected state 810. Pressing the knob 833 or another designated button then refocuses the presentation on Maine, which becomes the new hub.

If New Jersey were selected in FIG. 8D and the knob 822 pressed, the display would change to FIG. 8E. New Jersey is now represented by a circle 816. The level 804 now contains a set of records corresponding to the states neighboring New Jersey, hence neighboring states Pennsylvania and Delaware are represented on the schematic by 818.

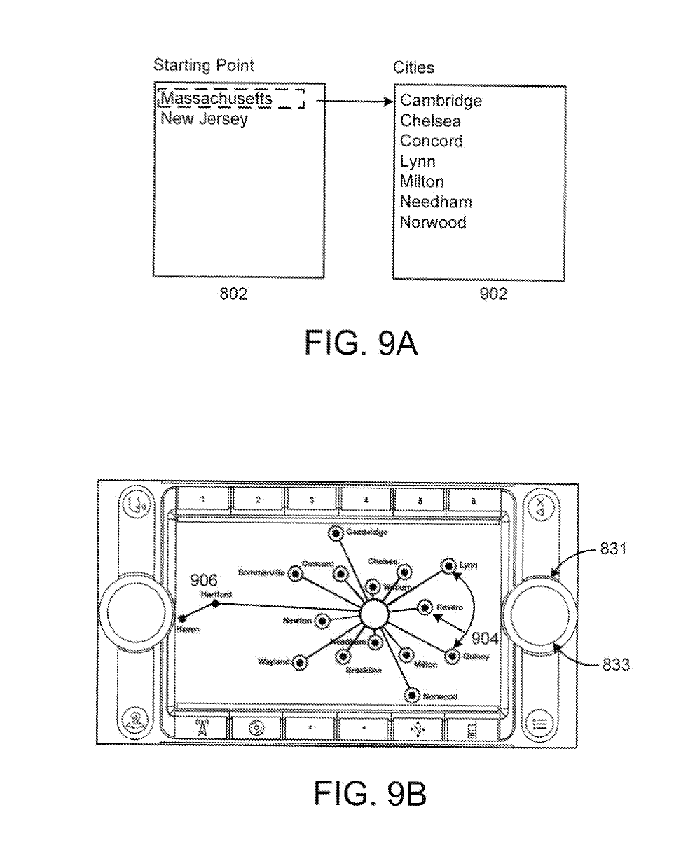

Pressing the knob 831 or another designated button while a state is highlighted as the hub changes the display to the next level of the hierarchy, as shown in FIGS. 9A and 9B, in which a set of items in a level 902 represent cities located within Massachusetts, the selected item from level 802. The states previously displayed are replaced by cities represented by dots, e.g., the dots 904 for Lynn, Revere, and Quincy. In this example, the cities are positioned in a direction and at a distance from a central circle corresponding to their geographic location relative to Boston. Additional cities are shown by the dots 906, which are lighter in color indicating that they are not within the currently selected state. Rotating the knob 831 will select among the cities as in the previous examples.

An icon showing progress through a set of records, as in FIGS. 2B, 2C, 3A, 3B, and 6B, is shown in more detail in FIG. 10. The icon 222 is surrounded by a ring 1004. An arc 1002 is displayed over a portion of ring 1004. The angle of the arc corresponds to the position of a presently active record in a list of all records in the present set. In FIG. 10, are 1002 has an angle of 120 degrees (out of a possible 360), indicating that a presently selected record (Delta) occupies a position ⅓ into the list of records in level 1006 of a hierarchical database. The first record, Alpha, would be represented by a 30 degree arc, while the final record, Mu, would be represented by a full circle (not shown). In comparing FIG. 2A to FIG. 3A, the size of icon 222 decreases after a selection is made at the first level for which it is displayed.

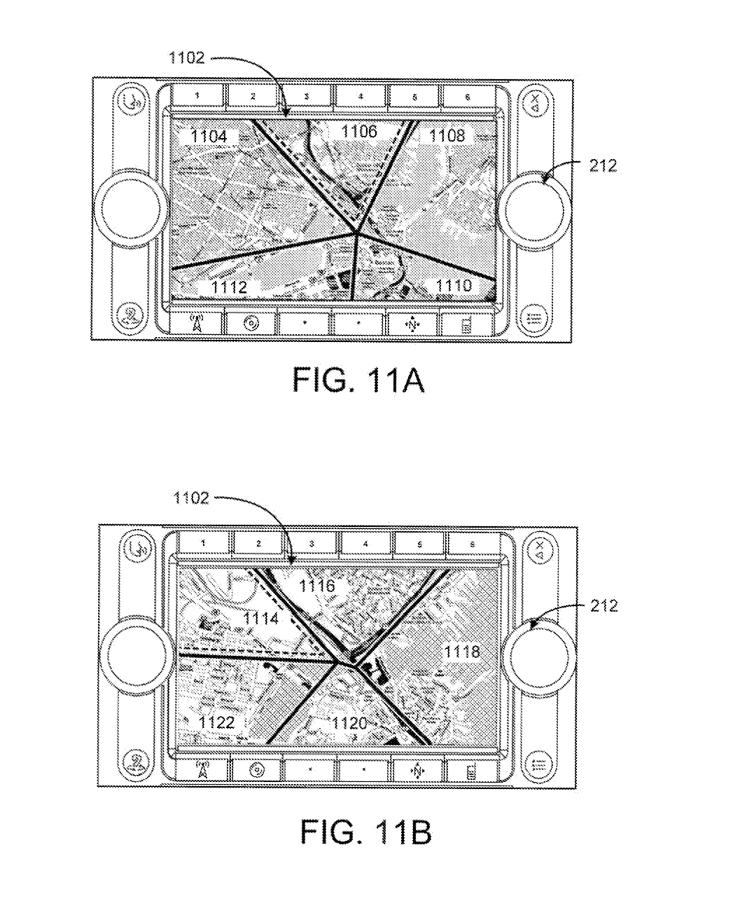

Several methods of determining the scope of a search, as discussed above, are facilitated by the visual display. For example, as shown in FIG. 11A, a displayed map 1102 may be broken into arbitrary pie segments 1104, 1106, 1108, 1110, and 1112. The map 1102 could also be broken into areas in other ways, such as in a grid or by geographic or political divisions. A user could visually browse the displayed areas by rotating the knob 212 as in the other examples, with different areas of the map being highlighted in succession. When a desired area is highlighted, e.g., the area 1106, the area is selected by pressing the knob 212 or another button, and other functions specific to the highlighted area are made available. This process may be useful for panning and scrolling through a map, for example. When a segment is selected, the user can zoom into that section, which may be broken into a number of new sub-area segments, which can be visually browsed as before. As shown in FIG. 11B, the area 1106 has been enlarged to fill the display area 1102, and new areas 1114, 1116, 1118, 1120, and 1122 are displayed, with the area 1114 selected. A method for zooming out from a selected area can also easily be accommodated.

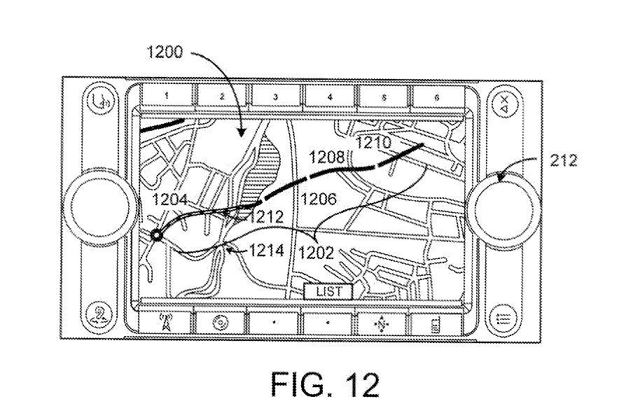

One useful application is to visually browse along a calculated route. The calculated route can be divided up into segments, as shown in FIG. 12. A database is searched to identify all segments 1204, 1206, 1208, and 1210 associated with the selected route 1202, all of which are displayed in map 1200. By turning the knob 212, or activating another control, various segments along the route are highlighted as in other examples. In FIG. 12, the segment 1204 is highlighted, as shown by a dotted line 1212. A zoom function could be provided to enable display of greater detail of a highlighted route section.

The hierarchy being browsed can relate to any information stored in any manner for use in any context.

A wide variety of user interface devices may be used as part of the method, including speech recognition.

Instead of requiring the user to turn the knob to advance the display to the next item at a level of the hierarchy, the advancing could be done automatically and the user could make a selection during a period when an item is being displayed.

in addition to browsing item at item at the bottom level of the hierarchy, e.g., one Chinese restaurant after another, the user may also browse through successive items at a higher level of the hierarchy. For example, turning the knob could first highlight all Chinese restaurants tan all Italian restaurants, and so forth.

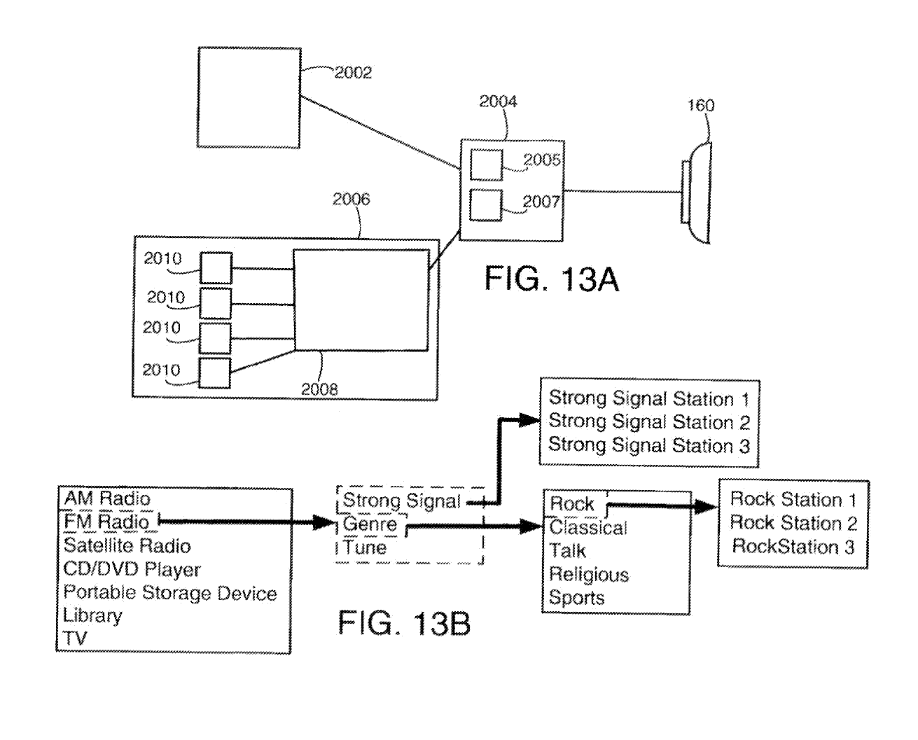

The devices and methods of FIGS. 1A-12 can be applied to the operation of the entertainment system of a vehicle. FIG. 13A is a block diagram including some of the elements of FIG. 1A showing some additional elements.

Navigation system 2002 is operatively coupled to interface 160 by display control module 2004. Interface 160 may include a display for displaying graphic images, which will be further explained below. Entertainment system 2006 includes control module 2008, which is operatively coupled to audio signal portals 2010. Control module 2008 is operatively coupled to display control module 2004. Other elements of the entertainment system, such as loudspeakers, amplifiers, audio signal processing elements, and the like are not shown in this view. For purpose of explanation, video control module 2004 is shown as a distinct element; however in other embodiments, the video control module can be a component of the navigation system 2002 or the entertainment system 2006 or comprise elements of both.

Audio signal portals 2010 may include a storage medium, such as a hard disk drive or memory; and FM receiver; an AM receiver; a satellite radio receiver; a portable storage device; a cell phone; the navigation system 2002; or other sources. Each audio signal portal 2010 may have associated with it a number of audio signal sources. For example if the audio signal portal is a CD/DVD drive, the audio signal sources may be tracks on a CD. If the audio signal portal is an FM or AM receiver, the audio signal sources may be radio stations, and so on.

In operation, the navigation system 2002 and the entertainment system 2006 transmit to video control module 2004 data that can be displayed graphically on the user display 200 of user interface 160 of FIG. 13A. The display control module 2004 determines what data is displayed on display 200. The graphically displayed data can be data from the navigation system, the entertainment system, or both. The operation of the display control module is controlled by a microprocessor 2005 running software instructions, which may be stored on a microprocessor readable medium 2007, for example, a memory, a hard disk, or other data storage device.

As represented in FIG. 13B, the entertainment system may have associated with it a database similar in structure to the database of FIG. 1B. At the root level are nodes representing audio source types, such as AM Radio, FM Radio, etc. At the second level in the hierarchical data base are nodes relating to the nodes of the root level. For example, relating to the node FM Radio may be the nodes Strong Signal, Genre, and Tune, examples of which will be described later. Under the Strong Signals node is a third level of nodes, for example, strong station 1, strong station 2, etc. Under the Genre node is a third and forth level of nodes, the third level corresponding to different genres (e.g., Rock, Classical, Talk, Religious, Sports, etc.) and the forth level of nodes corresponding to stations within the particular genre (e.g., Rock Station 1, Rock Station 2, etc.). The system categorizes the information into the nodes based on various information (e.g., metadata associated with stored content and RDS or similar data associated with broadcasted content).

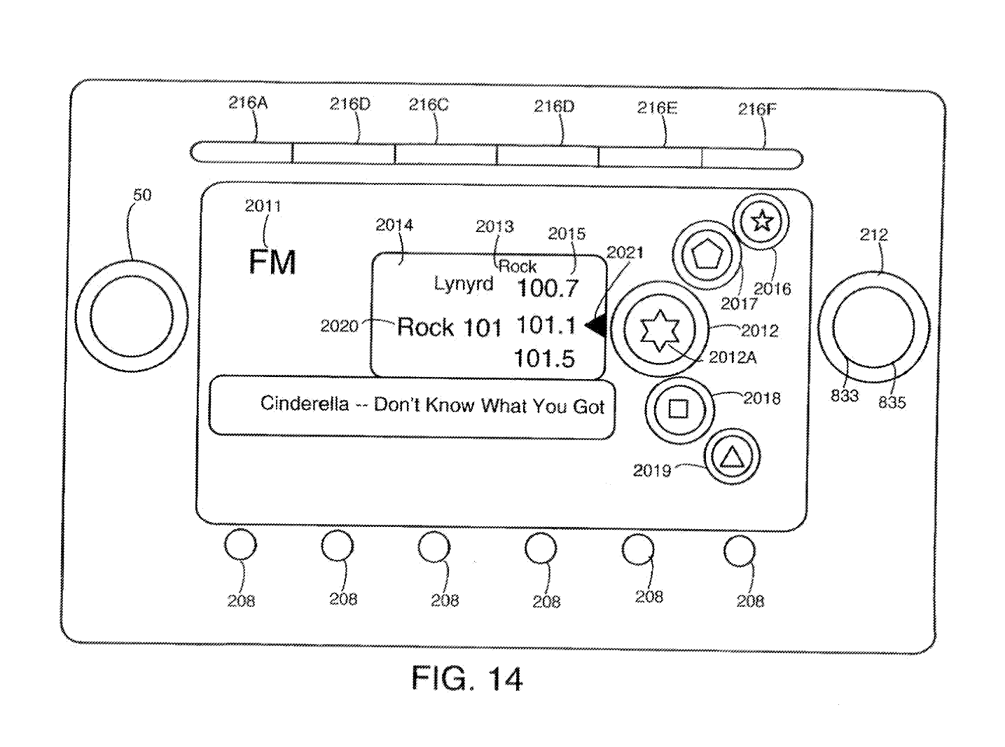

FIG. 14 shows elements of the display 200, including the data stored on the display screen. Knob 212 includes inner knob 833 and outer knob 835. Data displayed on the display screen includes a current display element 2012 and text sections 2014 and 2016.

The text section 2014 includes textual information about the node currently being scrolled and about certain nodes in the hierarchy above and below the node currently being scrolled. In the example of FIG. 14, the root node is the FM receiver audio signal portal, as indicated graphically by the FM indicator 2011.

The second level nodes being scrolled is Genre, which is graphically indicated by showing a series of display elements 2016, 2017, 2012, 2018, 2019 in a semi-circular pattern.

The third level of nodes currently being scrolled is the “Rock” genre, which is visually indicated icon 2012a within display element 2012 as well as the text “Rock” 2013 within the display window. Other available third level nodes are shown graphically by icons located within display elements 2016 (associated with, e.g., Classical genre), and 2019 (associated with, e.g., Sports genre). These other nodes can be selected by the user by rotating inner knob 833, which causes the display elements 2016, 2017, 2012, 2018 and 2019 to rotate in the same direction as the knob.

“Rock Stations” as indicated by text 2020. The currently indicated node and adjacent nodes in the hierarchy level below the currently indicated nodes are also displayed in the scrolling section 2015. In this example, the currently indicated node is “101.1” and the adjacent nodes are “100.7” and “101.5”. The display also includes a text section that includes other information, such as descriptive information about the currently indicated node. In this example, the information includes the RDS program service information (“Rock 101”) as well as information such as the track currently being played (“Cinderella—Don't Know What You Got”) and the artiest (Lynyrd).

Current selection icon 2012 provides a visual indicator of the node currently being scrolled. For simplicity, the icons in FIG. 14 are geometric figures. In an actual implementation, the icon for “Rock” might be, for example, a rock guitar. Icons 2016-2019 provide visual indicators of nodes that are adjacent to the node being scrolled. For example, instead of a pentagon, icon 2017 could be a violin, indicating Classical. The five pointed star in icon 2016 could be a microphone to indicate talk radio. As shown in FIG. 14, display elements 2012 and 2016-2019 also each include a concentric ring around the perimeter of the genre icon that will be discussed later.

As mentioned above, information displayed on the screen can be manipulated by physical operation of inner knob 833 and outer knob 835. In the implementation of FIG. 14, operating the inner knob causes the information in the display to scroll through the currently indicated node. For example, turning the knob clockwise would cause 101.5 to become the currently indicated node, and the information in the text section would change, so that it is descriptive of station 101.5, the node being scrolled. Operating the outer knob 835 changes the currently indicated node. For example, turning the outer knob 835 counter-clockwise would cause node 2017 to become the currently indicated node and would cause icon 2019 to no longer appear on the display. The contents of the scrolling section would be the FM stations corresponding to node 2017. If node 2017 were the “classical” node, the FM stations broadcasting classical music would be displayed in scrolling area 2015.

The information shown on display 200 is dependent on the audio signal portal selected by the user. For example, the examples of FIG. 14 show information associated with the FM audio signal portal. If a CD/DVD player is the selected audio signal portal, the information in the text area 2014 could be information about the CD, the items in the scroll section 2015 could the numbers or names of the tracks on the CD, and the text section could show information about the CD track currently being played. If the currently selected audio signal portal is satellite radio or AM, the information displayed might be similar to the information shown in FIG. 14, except instead of FM broadcast frequencies (e.g. 100.7, 101.1, 101.5) the information in scrolling area 2015 could be satellite radio channels or AM broadcast frequencies, respectively. Similarly, if the currently selected audio signal portal is a portable storage device or a hard disk drive or memory, the scroll section could show individual tracks, playlists, albums, artists, composers, and other information, and the text section 2014 could show information about the contents of the track or playlist, album, artist, or composer.

A button (for example one of buttons 208) or another dedicated button can be designated as an “options” button that permits the setting of options associated with the current audio signal portal selected. For example, if the current source is FM and an options button is pressed, the user may be presented with options such as changing the manner in which the user would like to navigate the FM source (e.g., by charging the second-level node from Genre to Strong Signals or Tune). Additionally, the user may be presented with other options such as assigning presets and finding alternate frequencies broadcasting the same program content. If the current source is AM, options presented could include assigning presets. If the current source is satellite radio, options could include assigning presets and assigning categories (for example “Decades”) to be shown. If the current audio signal portal is “TV”, options could include assigning presets or adjusting TV parameters such as brightness, contrast, and saturation. If the current source is “CD”, options presented could include auto-storing the content of a CD disk. If the current audio signal portal is a library (for example stored on an internal hard disk or memory), options presented could include sorting or managing the library. The displayed information would include information associated with the option being modified.

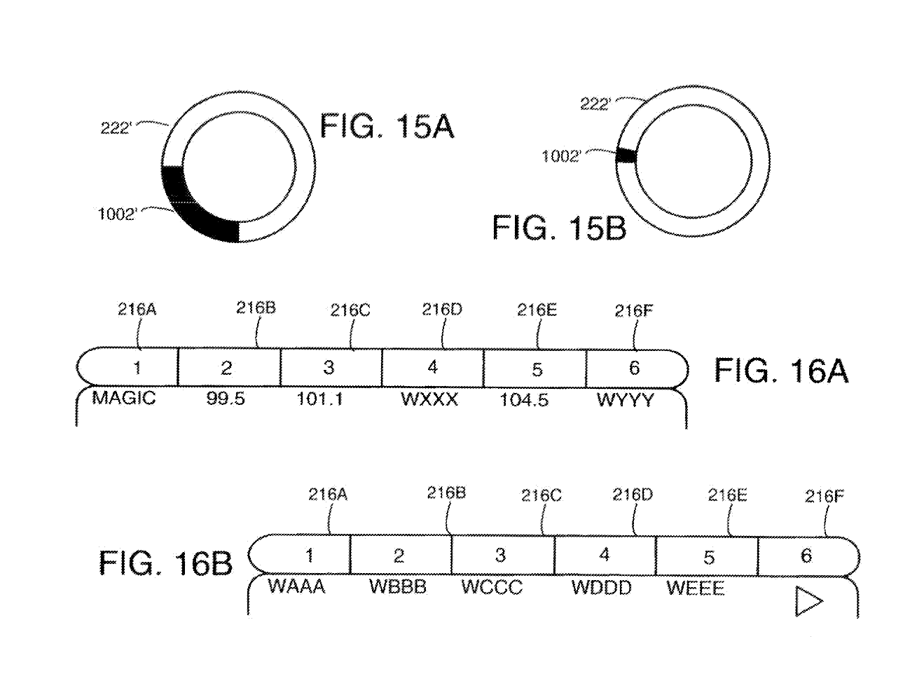

As shown in FIGS. 15A-15B, display elements 221a and 221b each include a concentric ring icon 222A-B around their perimeter. Within each ring icon 222A-B is a indicator arc 1002A, 1002B that provides a visual indication of the number of nodes in the hierarchical level below the node being scrolled, or in other words the number of selectable items that are related to the node being scrolled. If the indicator arc 1002A is relatively large (as shown in FIG. 15A), this indicates that there is a small n umber of nodes (or items) through which to scroll. If, however, the indicator arc is relatively small (as shown in FIG. 15B), this indicates that the number of nodes (or items) is relatively large. More precisely, if there are n selected items, the angular displacement of the arc

$$is \frac{1}{n} \times 360$$

degrees. The position of the arc on the ring indicates the position in the list.

For example in FIG. 15A, the arc 1002A has a central angle of 90 degrees, or ¼ of the circle, indicating that there are four selectable items. Taking the top (12 o'clock) position of the circle as the zero point and measuring clockwise, the arc begins at 180 degrees and occupies the third quadrant of the ring, indicating that the currently indicated node is the third of four indicatable items. As the user scrolls through the list of nodes (by turning outer knob 212 shown in FIG. 14), the indicator bar moves accordingly.

In FIG. 15B, the arc has a small included angle, indicating that the number n of indicatable items is large. If n is very large, the arc may become so small that it is difficult to see, so it may be desirable to set a maximum n, for example 32, above which the angle of the arc does not get any smaller. The position of the arc still indicates the position of the currently selected node in the total number of nodes. For example, if there are 100 nodes and there is a minimum arc size of

$$\frac{1}{32} \times 360 = 11.25$$

degrees, if the arc ends at 270 degrees, the currently selected node is the 75^{th} node out of the 100 nodes.

In another implementation the included angle of the arc could be

$$\frac{m}{n} \times 360$$

where m is the number of selectable items that are displayed on the display, in the example of FIG. 14, three.

The implementation of the ring icon that is shown in FIGS. 15A and 15B can be applied to the navigation system described above. For example, in the example shown in FIG. 10, there are 12 indicatable items (n=12). The included angle of the arc could be

$$\frac{1}{12} \times 360 = 30$$

degrees, and since the selected or indicated item (Delta) is the fourth item, the arc could end at

$$\frac{4}{12} \times 360 = 120$$

degrees.

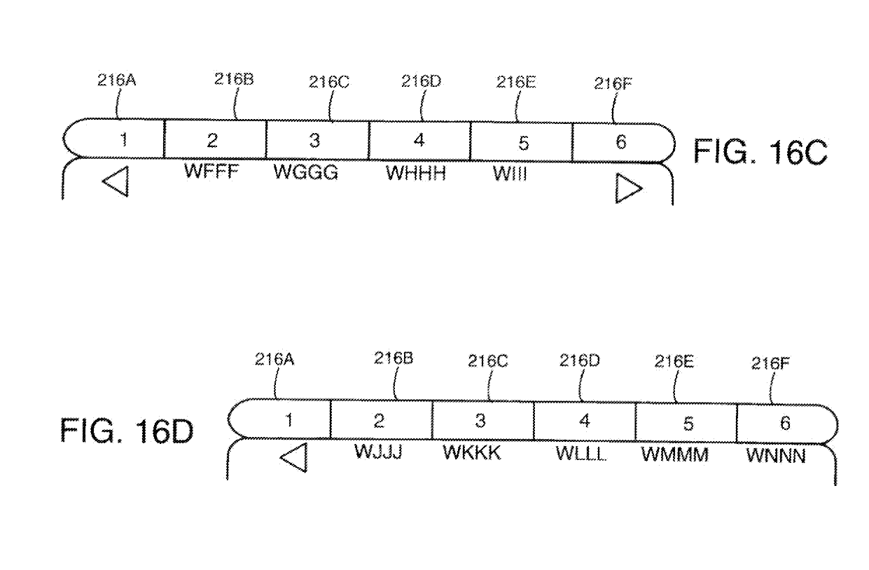

FIGS. 16A-16D show examples of the present indicator display depending on the number of presets the user has configured the system for. For example, as shown in FIG. 16A, the user has configured the system for six presets and has assigned six different stations to each of buttons 216A-F (e.g., “Magic” assigned to button 216A, 99.5 assigned to button 216B, and so on). However, in FIGS. 16B-16D the user has configured the system to allow the 14 preset stations. On the display screen adjacent a preset indicators, there is displayed an identifier of the radio station corresponding to the preset indicator. If desired, specific present indicators may be left unassigned, indicated by no identifier displayed adjacent it. The identifier may be a broadcast frequency (for 99.5, 101.1, and 104.5), call letters (WXXX and WYYY), and/or station name (MAGIC), or some other identifier available from RDS/RDBS data streams or other metadata. In FIG. 16B, the pointer adjacent preset indicator “6” indicates that there are more presets available. Selecting preset indicator “6” causes another set of presets to be displayed, for example as in FIG. 16C. In the arrangement of FIG. 16C, the leftward pointer adjacent the “1” preset indicator indicators that selecting preset indicator “1” would result in more presets being displayed, for example the arrangement of FIG. 16B. The rightward pointer adjacent the “6” preset indicator indicates that selecting preset indicator “6” would still another set of presets being displayed, for example as in FIG. 16D.

The audio sources associated with the preset indicators depend on the audio signal portal. In the example above the audio signal portal is an FM receiver, so the audio signal sources represented by the preset indicators are FM radio stations. If the audio signal is a satellite radio receiver, the audio signal sources could be satellite radio channels. If the audio signal portal is a CD/DVD player, the audio signal source could be a track, and so on. Presets can also be assigned for other portals, such as phone, voice memo, and navigation.

The apparatuses and methods of FIGS. 13B, 14, 15A, 15B, and 16 have been described as applied to a vehicle entertainment system, however they may also be applied to a home entertainment audio system with a display.

Other implementations are within the scope of the following claims.

1. A method for graphically representing content of a database in an automobile entertainment system, the method comprising
presenting a primary display element on a display, wherein the primary display element represents a first node in a first hierarchical level of the data base; and
presenting a secondary display element on the display, wherein the secondary display element includes a graphical indicator that varies in size according to the number of nodes in a second hierarchical level below the first hierarchical level of the database.

2. The method of claim 1 wherein the primary display element comprises an icon representative of the first node.

3. The method of claim 1 wherein the secondary display element comprises a ring-shaped graphical element.

4. The method of claim 1 wherein the graphical indicator comprises a highlighted arc within the ring-shaped graphical element.

5. The method of claim 4 wherein the highlighted the arc is described be a central angle equal to
$$\frac{m}{n} \times 360$$
degrees, where n is the number of nodes in the second hierarchical level below the first hierarchical level that are associated with the first node, and m is one of 1 and
the number of nodes in the hierarchical level below the first hierarchical level that are represented on the display.

6. A method in accordance with claim 1, wherein m=1 and further comprising highlighting an arc of the ring, the arc described by a central angel equal to
$$\frac{1}{{n}_{max}} \times 360$$
degrees when n is equal to or greater than nₘₐₓ.

7. A method in accordance with claim 1, wherein m is the number of nodes in the hierarchical level below the first hierarchical level that are represented on the display and further comprising
highlighting an arc of the ring, the arc described by a central angle equal to
$$\frac{m}{{n}_{max}} \times 360$$
degrees when n is equal to or greater than nₘₐₓ.

8. A method in accordance with claim 1, further comprising
causing the arc to be displaced from a starting point be an angular and
representing an incrementing through the n nodes by incrementing the angular distance by
$$\frac{1}{n} \times 360$$
degrees.

9. In an automobile entertainment system, a method for graphically representing elements of database comprising a plurality of nodes that are arranged in a predetermined order, the method comprising:
providing a control knob for navigating through nodes presented on a display of the vehicle entertainment system;
presenting on the display a first graphical element representative of a selected node; and
presenting on the display a second and third graphical element associated with a respective second and third node that are each adjacent to the selected node in the predetermined order, wherein the first, second and third graphical elements are arranged in an approximately circular or semi-circular fashion such that as the control knob is rotated selection between the first, second, and third graphical elements is similarly rotated.

10. The method of claim 9 wherein at least the first graphical element includes a graphical indicator that graphically shows the n umber of sub-selections under the selected node.

11. The method of claim 10 wherein the graphical indicator comprises a highlighted are within a ring.

12. The method of claim 9, further comprising:
causing a fourth graphical element associated with a fourth node to appear on the screen as the user rotates the control knob.

13. A method of claim 9, wherein the first, second and third graphical elements move on the display in the rotary direction of the control knob when rotated by the user.

14. A method of claim 9, further comprising providing a second control knob for selecting between sub-selections under the selected node.

15. The method of claim 14 wherein the second control knob is concentric with the first control knob.

16. The method of claim 14 wherein the graphical indicators moves as the second control knob is rotated.

17. A method for displaying audio signal sources each audio signal source corresponding to one of a plurality of preset indicators, comprising:
on a display screen, adjacent a first preset indicator, displaying an audio signal source corresponding to the first preset indicator;
displaying adjacent a second preset indicator a first graphical indicator that there are additional audio signal sources each corresponding to one of the plurality of preset indicators; and
upon selection of the second preset indicator, displaying a second audio signal source corresponding to the first preset indicator.

18. A method in accordance with claim 17, wherein the number of audio signal sources is greater than the number of preset indicators.

19. A method in accordance with claim 17, further comprising displaying adjacent a third preset indicator a second graphical indicator that there are additional audio signal sources each corresponding to one of the plurality of preset indicators; and
upon selection of the third preset indicator displaying a third audio signal source corresponding to the first preset indicator.

20. An audio system comprising:
a number N of input elements each associated with a particular radio station such then when the input element is actuated by a user the audio system tunes to the particular radio station; and
a user interface that permits the user to change the number of particular radio stations that may be stored from a first value to a second value, wherein at least the second value is greater than N.

21. A method for graphically representing data base elements on a display, the method comprising:
causing an icon to appear on a display, the icon representing a first node in a first hierarchical level of a data base;
causing a ring to appear around the icon; and
highlighting an arc of the ring, the arc described by an included angle, wherein the magnitude of the included angle is related to the number of elements in a hierarchical level below the first hierarchical level associated with the first node.

22. The method of claim 21 wherein the position of the arc along the circumference of the ring is related to the position of a highlighted element of the hierarchical level below the first hierarchical level within its hierarchical level.

23. The method of claim 21 wherein the magnitude of the included angle is inversely proportional to the number of elements in the hierarchical level below the first hierarchical level associated with the first node.

24. The method of claim 21, wherein the display is associated with a vehicle entertainment system.

25. The method of claim 24 wherein the display is further associated with a vehicle navigation system
